(19) United States
(12) Patent Application Publication
(10) Pub. No.: US 2026/0277842 A1
(43) Pub. Date: Sep. 17, 2026

(54) CONTROLLING CIRCUIT

(71) Applicant: ASMedia Technology Inc., New Taipei City (TW)

(72) Inventor: Chun-Jung Hsu, New Taipei City (TW)

(73) Assignee: ASMedia Technology Inc., New Taipei City (TW)

(21) Appl. No.: 19/093,298

(22) Filed: Mar. 28, 2025

(30) Foreign Application Priority Data
Mar. 12, 2025 (TW) 114109114

(51) Int. Cl. G06F 13/40; G06F 13/38; G06F 13/42

(52) U.S. Cl. CPC G06F 13/4027; G06F 13/387; G06F 13/4282

(57) ABSTRACT

Provided is a controlling circuit adapted for bridging between a host device and multiple storage devices. The controlling circuit includes a bridge controller and a disk array controller. The bridge controller includes an upstream facing port (UFP) interface circuit, a downstream facing port (DFP) interface circuit, and a routing circuit. The UFP interface circuit couples the host device to the routing circuit based on a first transmission specification. The DFP interface circuit couples the routing circuit to the storage devices based on a second transmission specification. The disk array controller is coupled to the routing circuit and the DFP interface circuit. The disk array controller accesses the storage devices through the DFP interface circuit, thereby improving data access performance.

### CROSS-REFERENCE TO RELATED APPLICATION

This application claims the priority benefit of Taiwan application serial no. 114109114, filed on Mar. 12, 2025. The entirety of the above-mentioned patent application is hereby incorporated by reference herein and made a part of this specification.

### BACKGROUND

### Technical Field

The disclosure relates to a controlling circuit, and particularly relates to a controlling circuit adapted for bridging between a host device and multiple storage devices.

### Related Art

Based on various transmission specifications, a host may access one or more terminal devices through a bridge circuit. The terminal devices may be, for example, a non-volatile memory express (NVMe) device(s). The NVMe device(s) may be organized into a logical array to form a redundant array of independent disks (RAID). RAID may also be referred to as a disk array.

However, current bridge circuits need to cooperate with external devices such as switches or control units to bridge the host and multiple NVMe devices, and to implement RAID functions accordingly. As such, the host cannot directly access one or more NVMe devices through the bridge circuit, thereby reducing data access performance.

### SUMMARY

An embodiment of the disclosure provides a controlling circuit adapted for bridging between a host device and multiple storage devices, and capable of avoiding the need to connect external devices in order to implement RAID functions to improve data access performance.

The controlling circuit according to an embodiment of the disclosure includes a bridge controller and a disk array controller. The bridge controller includes an upstream facing port (UFP) interface circuit, a downstream facing port (DFP) interface circuit, and a routing circuit. The upstream facing port interface circuit is configured to couple the host device to the routing circuit based on a first transmission specification. The downstream facing port interface circuit is configured to couple the routing circuit to multiple storage devices based on a second transmission specification. The disk array controller is coupled to the routing circuit and the downstream facing port interface circuit. The disk array controller is configured to access the multiple storage devices through the downstream facing port interface circuit.

Based on the above, the controlling circuit according to an embodiment of the disclosure, by integrating the bridge controller and the disk array controller together, is capable of avoiding the need to connect external devices in order for the host device to access the multiple storage devices to implement RAID functions, thereby improving data access performance.

To make the foregoing characteristics and advantages of the disclosure more comprehensible, embodiments are presented below with detailed explanations in conjunction with the accompanying drawings.

### BRIEF DESCRIPTION OF THE DRAWINGS

FIG. 1 is a circuit block diagram of a controlling circuit according to an embodiment of the disclosure.

FIG. 2 is a circuit block diagram of a controlling circuit according to another embodiment of the disclosure.

FIG. 3 is a circuit block diagram of a controlling circuit according to another embodiment of the disclosure.

### DESCRIPTION OF THE EMBODIMENTS

Some embodiments of the disclosure will be described in detail with reference to the accompanying drawings. In the following description, when the same reference numeral appears in different drawings, the reference numeral will be regarded as the same or similar component. The embodiments are merely a part of the disclosure and do not disclose all possible implementations of the disclosure. More precisely, the embodiments are merely examples within the range of the appended claims of the disclosure.

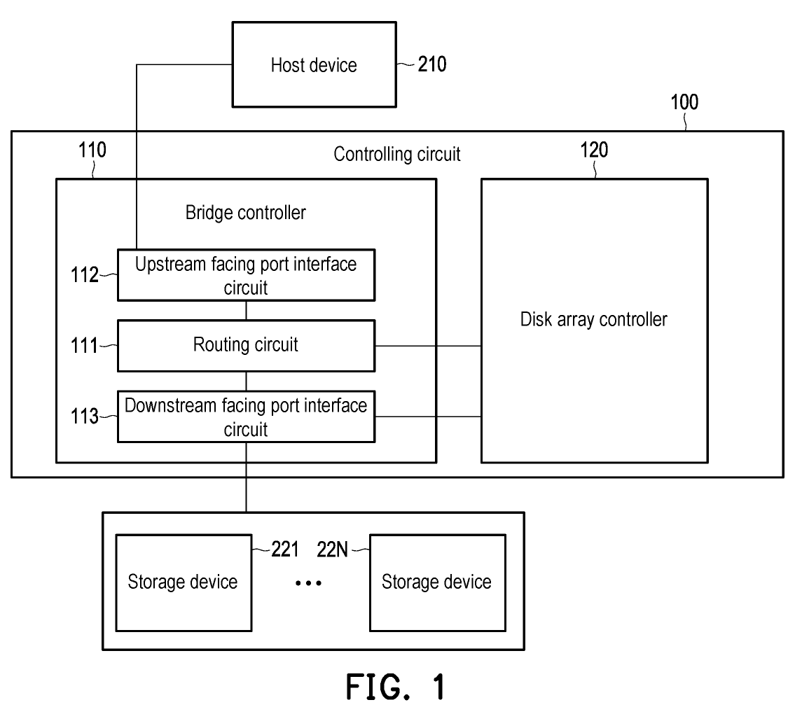

FIG. 1 is a circuit block diagram of a controlling circuit according to an embodiment of the disclosure. Referring to FIG. 1, a controlling circuit 100 is adapted for bridging between a host device 210 and multiple storage devices 211 to 22N, in which N is a positive integer greater than 1. The controlling circuit 100 may be coupled to the host device 210 based on a first transmission specification, and may be coupled to the multiple storage devices 211 to 22N based on a second transmission specification. The first transmission specification is different from the second transmission specification.

In this embodiment, the multiple storage devices 211 to 22N may be, for example, NVM Express (NVMe) devices. The storage devices 211 to 22N are organized into a logical array to form a redundant array of independent disks (RAID) (that is, a disk array).

In this embodiment, the host device 210 may directly access one or more storage devices 211 to 22N through the controlling circuit 100 to implement RAID functions. The host device 210 may be, for example, electronic devices such as mobile phones, computer devices, tablets, laptops, and desktop computers.

In the embodiment of FIG. 1, the controlling circuit 100 includes a bridge controller 110 and a disk array controller (that is, a RAID controller) 120. The bridge controller 110 is coupled to the disk array controller 120.

In detail, the bridge controller 110 includes a routing circuit 111, an upstream facing port (UFP) interface circuit 112, and a downstream facing port (DFP) interface circuit 113. The upstream facing port interface circuit 112 is configured to couple the host device 210 to the routing circuit 111 based on the first transmission specification. The downstream facing port interface circuit 113 is configured to couple the routing circuit 111 to the multiple storage devices 211 to 22N based on the second transmission specification.

In other words, the routing circuit 111 is configured to transmit data conforming to different transmission specifications. For example, the routing circuit 111 receives data from the host device 210 through the upstream facing port interface circuit 112. The data conforms to the first transmission specification. The routing circuit 111 converts the data into data conforming to the second transmission specification. The routing circuit 111 further outputs the data conforming to the second transmission specification through the downstream facing port interface circuit 113 to the multiple storage devices 211 to 22N, or to the disk array controller 120.

In this embodiment, the disk array controller 120 and the bridge controller 110 are integrated in the same circuit architecture. That is, the disk array controller 120 is not coupled to the input/output terminal (for example, the downstream facing port interface circuit 113) of the bridge controller 110 as an external component through a transmission line (or transmission interface).

Specifically, the disk array controller 120 is coupled to the routing circuit 111 and the downstream facing port interface circuit 113. As such, the disk array controller 120 may access the data output by the routing circuit 111. The data conforms to the second transmission specification. The disk array controller 120 may further access the multiple storage devices 211 to 22N through the downstream facing port interface circuit 113 to implement RAID functions.

It is worth mentioning that, by integrating the disk array controller 120 and the bridge controller 110, the controlling circuit 100 is capable of avoiding the need to connect other external devices such as switches or control units, allowing the host device 210 to directly access the multiple storage devices 211 to 22N through the controlling circuit 100 to implement RAID functions. As a result, the controlling circuit 100 is capable of improving data access performance.

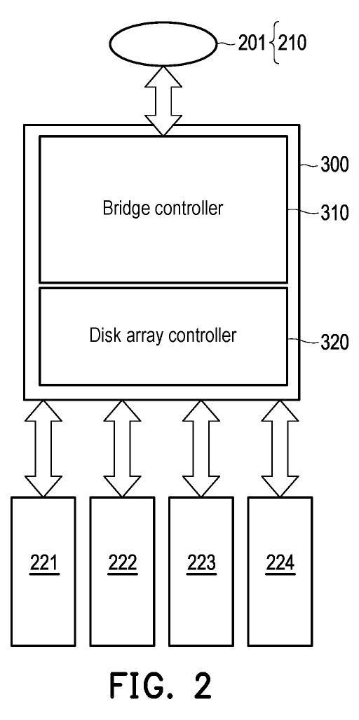

FIG. 2 is a circuit block diagram of the controlling circuit according to another embodiment of the disclosure. Referring to FIG. 2, a controlling circuit 300 is adapted for bridging between a host device 210 and multiple storage devices 221 to 224, in which the number of the storage devices 221 to 224 is merely for illustrative purposes. The host device 210 may be coupled to the controlling circuit 300 through its own connector 201, and directly access the multiple storage devices 221 to 224 through the controlling circuit 300 to implement RAID functions. The connector 201 may be, for example, a universal serial bus type-C (USB Type-C) connector.

In this embodiment, the multiple storage devices 221 to 224 may be, for example, NVMe devices. The storage devices 221 to 224 include at least one of at least one solid-state disk (SSD) and at least one hard disk drive (HDD). That is, each storage device 221 to 224 may be, for example, an SSD or an HDD.

In the embodiment of FIG. 2, the controlling circuit 300 includes a bridge controller 310 and a disk array controller 320. For the bridge controller 310 and the disk array controller 320, reference may be made to the related description of the controlling circuit 100, and may be analogized accordingly.

In this embodiment, the controlling circuit 300 is coupled to the host device 210 based on the first transmission specification through an upstream facing port interface circuit thereof (not shown in FIG. 2), and is configured to transmit data conforming to the first transmission specification. The first transmission specification includes universal serial bus (USB) specification (for example, USB4 specification) or thunderbolt (TBT) specification (for example, TBT5 specification).

In this embodiment, the bridge controller 310 may be, for example, a USB4 bridge controller. Alternatively, the bridge controller 310 may be, for example, a TBT accessory controller compatible with TBT specifications such as TBT3, TBT4, and TBT5.

In this embodiment, the controlling circuit 300 is further coupled to the multiple storage devices 221 to 224 based on the second transmission specification through a downstream facing port interface circuit thereof (not shown in FIG. 2), and is configured to transmit data conforming to the second transmission specification. The second transmission specification includes peripheral component interconnect express (PCI express, PCIe) specification.

That is, the first transmission interface between the connector 201 and the controlling circuit 300 conforms to USB4 specification or TBT specification. The first transmission interface may be, for example, a USB Type-C transmission line. In addition, the second transmission interface between the controlling circuit 300 and each storage device 221 to 224 conforms to PCIe specification. The second transmission interface may be, for example, a serial advanced technology attachment (Serial ATA, SATA) transmission interface, a serial attached SCSI (SAS) transmission interface, or a non-volatile memory express (NVMe) transmission interface.

It should be noted that the bridge controller 310 and the disk array controller 320 are disposed on the same chip. That is, the bridge controller 310 and the disk array controller 320 are integrated in the same controller. The controller may be implemented as an integrated circuit, for example. In this way, the controlling circuit 300 is capable of not only implementing data transmission functions conforming to various transmission specifications (that is, USB4/TBT and PCIe), but also implementing RAID functions.

In addition, since the controlling circuit 300 does not need to connect to an external PCIe switch and/or a RAID controller to provide RAID functions, the controlling circuit 300 can reduce the cost of RAID applications for the host device 210.

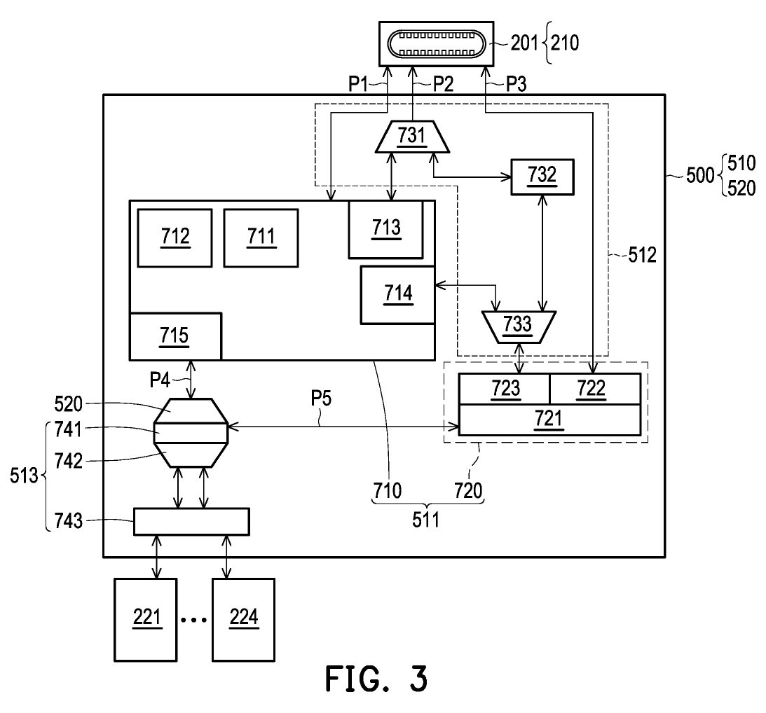

FIG. 3 is a circuit block diagram of a controlling circuit according to another embodiment of the disclosure. Referring to FIG. 3, the controlling circuit 500 is adapted for bridging between a host device 210 and multiple storage devices 221 to 224. The controlling circuit 500 includes a bridge controller 510 and a disk array controller 520. The bridge controller 510 includes a routing circuit 511, an upstream facing port interface circuit 512, and a downstream facing port interface circuit 513. For the routing circuit 511, the upstream facing port interface circuit 512, the downstream facing port interface circuit 513, and the disk array controller 520, reference may be made to the related descriptions of the controlling circuit 100 and the controlling circuit 300, and may be analogized accordingly.

In this embodiment, the routing circuit 511 includes an adapter circuit 710 and an enhanced superspeed function circuit 720. The adapter circuit 710 may be, for example, a device router supporting USB specifications such as USB3 and USB4, and TBT specifications such as TBT3, TBT4, and TBT5. The enhanced superspeed function circuit 720 may be, for example, a module circuit supporting USB3.2 specification to implement enhanced superspeed transmission functions.

Specifically, the adapter circuit 710 is coupled to the upstream facing port interface circuit 512 and the disk array controller 520. The adapter circuit 710 is configured to convert data conforming to USB4 specification, USB3 specification, TBT specification, or PCIe specification, and transmit the converted data.

In detail, the adapter circuit 710 includes a control adapter 711, a time management unit (TMU) 712, a channel adapter 713, a USB adapter 714, and a PCIe adapter 715. The time management unit 712 couples multiple adapters 711 and 713 to 715. The time management unit 712 is configured to synchronize the adapters 711 and 713 to 715. The control adapter 711 is further coupled to the channel adapter 713, the USB adapter 714, and the PCIe adapter 715. The control adapter 711 is configured to control the adapters 713 to 715.

In addition, the channel adapter 713 is further coupled to the upstream facing port interface circuit 512. The channel adapter 713 is configured to process (including, convert) data conforming to USB4/TBT specification, compatible USB specification, or PCIe specification, and transmit the processed data. The USB adapter 714 is further coupled to the enhanced superspeed function circuit 720 through the upstream facing port interface circuit 512. The USB adapter 714 is configured to process data conforming to USB3 or PCIe specification, and transmit the processed data. The PCIe adapter 715 is further coupled to the disk array controller 520. The PCIe adapter 715 is configured to process data conforming to PCIe, USB3, or USB4/TBT specification, and transmit the processed data.

In this embodiment, the enhanced superspeed function circuit 720 is coupled to the upstream facing port interface circuit 512, the disk array controller 520, and the downstream facing port interface circuit 513. The enhanced superspeed function circuit 720 is configured to convert data conforming to USB3 or PCIe specification, and transmit the converted data.

In detail, the enhanced superspeed function circuit 720 includes a virtual non-volatile memory express (NVM Express, NVMe) host 721, a USB2.0 device controller 722, and a USB3.2 device controller 723. The virtual NVMe host 721 is coupled to the USB2.0 device controller 722, the USB3.2 device controller 723, the disk array controller 320, and the downstream facing port interface circuit 513. The virtual NVMe host 721 is configured to control the USB2.0 device controller 722 and the USB3.2 device controller 723, and assign targets to be accessed among the multiple storage devices 221 to 224.

In addition, the USB2.0 device controller 722 further couples the upstream facing port interface circuit 512. The USB2.0 device controller 722 is configured to process data conforming to USB2 or PCIe specification, and transmit the processed data. The USB3.2 device controller 723 further couples the USB adapter 714 through the upstream facing port interface circuit 512. The USB3.2 device controller 723 is configured to process data conforming to USB3 or PCIe specification, and transmit the processed data.

In this embodiment, the upstream facing port interface circuit 512 includes a demultiplexer 731, a USB3.2 physical coding sub-layer (PCS) circuit 732, and a multiplexer 733. The input terminal of the demultiplexer 731 is coupled to the connector 201. Multiple output terminals of the demultiplexer 731 are coupled to the channel adapter 713 and the USB3.2 PCS circuit 732. The USB3.2 PCS circuit 732 further couples an input terminal of the multiplexer 733. Another input terminal of the multiplexer 733 couples the USB adapter 714. The output terminal of the multiplexer 733 is coupled to the USB3.2 device controller 723.

In RAID applications, the upstream facing port interface circuit 512 has multiple transmission paths P1 to P4 between the connector 201 and the routing circuit 511. The transmission paths P1 to P4 support USB specifications such as USB3 specification and USB4 specification, as well as TBT specifications such as TBT3, TBT4, and TBT5.

In detail, in the transmission path P1, the upstream facing port interface circuit 512 transmits data conforming to USB4 specification between the connector 201 and the adapter circuit 710 through a sideband (SB) channel (that is, SBTX/RX).

In the transmission path P2, the upstream facing port interface circuit 512 couples the connector 201 and the channel adapter 713 together through the demultiplexer 731, so as to transmit data conforming to USB3 specification between the connector 201 and the adapter circuit 710. Alternatively, the upstream facing port interface circuit 512 couples the connector 201 and the USB3.2 device controller 723 together through the demultiplexer 731, the USB3.2 PCS circuit 732, and the multiplexer 733. Thus, in the transmission path P2, the upstream facing port interface circuit 512 transmits data conforming to USB3.2 specification between the connector 201 and the enhanced superspeed function circuit 720.

In the transmission path P3, the upstream facing port interface circuit 512 transmits data conforming to USB2 specification between the connector 201 and the USB2.0 device controller 722 through a data channel (that is, D+/D-).

In this embodiment, the downstream facing port interface circuit 513 includes multiple PCIe switch controllers 741 to 742 and a PCIe physical layer circuit 743. The PCIe switch controller 741 may be, for example, a PCIe switch upstream facing port controller. The PCIe switch controller 742 may be, for example, a PCIe switch downstream facing port controller. The PCIe switch controllers 741 to 742 are coupled to the disk array controller 520 and the routing circuit 511, and are further coupled to the PCIe physical layer circuit 743.

In RAID applications, the downstream facing port interface circuit 513 has multiple transmission paths P4 to P5 between the routing circuit 511 and the multiple storage devices 221 to 224. The transmission paths P4 to P5 support PCIe specification.

In detail, in the transmission path P4, the PCIe switch controller 741 processes data conforming to PCIe specification, and transmits the processed data between the virtual NVMe host 721 and the PCIe physical layer circuit 743. In the transmission path P5, the PCIe switch controller 742 processes data conforming to PCIe specification, and transmits the processed data between the PCIe physical layer circuit 743 and the PCIe adapter 715. Thus, the processed data conforms to PCIe specification, and is accessed to the multiple storage devices 221 to 224 through the PCIe physical layer circuit 743.

It should be noted that the disk array controller 520 may be integrated with the multiple PCIe switch controllers 741 to 742 in the same circuit module. In this way, the controlling circuit 500 is able to reduce the layout area, thereby lowering production costs.

In summary, the controlling circuit according to the embodiments of the disclosure, by integrating the disk array controller and the bridge controller on the same chip, is capable of avoiding the need to connect additional external devices in RAID applications, thereby improving data access performance. The controlling circuit is further able to reduce the layout area, thereby lowering production costs.

Although the disclosure has been disclosed by the foregoing embodiments, the embodiments are not intended to limit the disclosure. Persons with ordinary knowledge in the technical field may make some changes and modifications without departing from the spirit and range of the disclosure. Therefore, the protection range of the disclosure should be defined by the appended claims.

What is claimed is:

1. A controlling circuit adapted for bridging between a host device and a plurality of storage devices, comprising:
a bridge controller comprising an upstream facing port interface circuit, a downstream facing port interface circuit, and a routing circuit, wherein the upstream facing port interface circuit is configured to couple the host device to the routing circuit based on a first transmission specification, and the downstream facing port interface circuit is configured to couple the routing circuit to the storage devices based on a second transmission specification; and
a disk array controller coupled to the routing circuit and the downstream facing port interface circuit, and configured to access the storage devices through the downstream facing port interface circuit.

2. The controlling circuit as claimed in claim 1, wherein the bridge controller and the disk array controller are disposed on the same chip.

3. The controlling circuit as claimed in claim 1, wherein the first transmission specification comprises universal serial bus (USB) specification or thunderbolt (TBT) specification.

4. The controlling circuit as claimed in claim 1, wherein the second transmission specification comprises peripheral component interconnect express (PCI Express, PCIe) specification.

5. The controlling circuit as claimed in claim 1, wherein the downstream facing port interface circuit comprises:
a plurality of PCIe switch controllers coupled to the disk array controller and the routing circuit; and
a PCIe physical layer circuit coupled to the PCIe switch controllers.

6. The controlling circuit as claimed in claim 1, wherein the routing circuit comprises:
an adapter circuit coupled to the upstream facing port interface circuit and the disk array controller, and configured to convert data conforming to USB4 specification, USB3 specification, TBT specification, or PCIe specification to transmit converted data; and
an enhanced superspeed function circuit coupled to the upstream facing port interface circuit, the disk array controller, and the downstream facing port interface circuit, and configured to convert data conforming to USB3 specification or PCIe specification to transmit converted data.

7. The controlling circuit as claimed in claim 6, wherein the adapter circuit comprises:
a channel adapter coupled to the upstream facing port interface circuit;
a USB adapter coupled to the enhanced superspeed function circuit through the upstream facing port interface circuit;
a PCIe adapter coupled to the disk array controller; and
a control adapter coupled to the channel adapter, the USB adapter, and the PCIe adapter.

8. The controlling circuit as claimed in claim 7, wherein the enhanced superspeed function circuit comprises:
a USB2.0 device controller coupled to the upstream facing port interface circuit;
a USB3.2 device controller coupled to the USB adapter through the upstream facing port interface circuit; and
a virtual non-volatile memory express (NVM Express, NVMe) host coupled to the USB2.0 device controller, the USB3.2 device controller, the disk array controller, and the downstream facing port interface circuit.

9. The controlling circuit as claimed in claim 8, wherein the upstream facing port interface circuit comprises:
a USB3.2 physical coding sub-layer (PCS) circuit;
a demultiplexer having an input terminal coupled to the host device, wherein a plurality of output terminals of the demultiplexer are coupled to the channel adapter and the USB3.2 PCS circuit; and
a multiplexer having a plurality of input terminals coupled to the USB adapter and the USB3.2 PCS circuit, wherein an output terminal of the multiplexer is coupled to the USB2.0 device controller.

10. The controlling circuit as claimed in claim 1, wherein the storage devices comprise at least one of at least one solid-state disk (SSD) and at least one hard disk drive (HDD).
